(19) United States
(12) Patent Application Publication
(10) Pub. No.: US 2010/0294248 A1
(43) Pub. Date: Nov. 25, 2010

(54) Carburetor with acceleration pump

(75) Inventor: Korehito Kawase, Kanagawa-ken (JP)

Correspondence Address: RADER FISHMAN & GRAUER PLLC, LION BUILDING, 1233 20TH STREET N.W., SUITE 501, WASHINGTON, DC, 20036, US

(73) Assignee: NIKKI CO., LTD., Atsugi-shi (JP)

(21) Appl. No.: 12/662,766

(22) Filed: May 3, 2010

(30) Foreign Application Priority Data
May 20, 2009 (JP) 2009-121973

(51) Int. Cl. F02M 37/04

(52) U.S. Cl. 123/495; 261/34.2

(57) ABSTRACT

In the carburetor 1A with the acceleration pump of the present embodiment, when a plunger 16 is stopped at the position of a top dead center in a cylinder 10 and the acceleration pump mechanism is not operated as in an idle operation or the like, a gap w having a predetermined width is formed between the tip of a rod 14A and a rod abutment face 16a of the plunger 16, whereby an operational error generated in a link system which transmits the opening/closing operation of a throttle valve to the rod is eliminated through this gap.

### BACKGROUND OF THE INVENTION

1. Field of the Invention

The present invention relates to a carburetor with an acceleration pump. More particularly, it relates to a carburetor with an acceleration pump, comprising a pump mechanism for supplying a fuel necessary for acceleration in conjunction with the opening operation of a throttle valve during the acceleration of an engine.

2. Description of Related Art

In a general-purpose engine or the like in which a carburetor is used for the supply of a fuel, the fuel supplied from the carburetor runs short during acceleration involving a rapid throttle opening operation, and hence the operability of the engine is impaired sometimes. To eliminate this fuel shortage, a carburetor 1B with an acceleration pump shown in FIG. 3 is used as disclosed in Japanese Patent Application Laid-Open No. 5-280426 and 10-288092.

An acceleration pump mechanism provided in this carburetor 1B with the acceleration pump has a constitution in which a throttle lever 11 is opened to depress the tip of an acceleration lever 13 via an acceleration spring 12, thereby lowering a rod 14B which is vertically provided from the tip of the acceleration lever 13 and into which a guide 15B is inserted, to depress a plunger 16 against the spring pressure of a return spring 17.

Moreover, a fuel in a cylinder 10, which has been compressed by lowering the plunger 16, passes through an acceleration fuel passage 18 and a check valve 19, and the fuel is jetted toward an intake manifold through an acceleration nozzle 20 opened in a suction passage 2, and supplied as the acceleration fuel to the engine.

According to the carburetor 1B with the acceleration pump having such a constitution, the acceleration fuel can be supplied during the acceleration of the engine, whereby the satisfactory operation performance of the engine can be acquired. However, the carburetor operates in a state in which the tip of the rod 14B of the acceleration pump mechanism constantly comes in contact with the plunger 16, and hence an error generated in a link system of the acceleration pump mechanism has an influence on a plunger stroke as it is. This causes a problem that the discharge amount of the acceleration pump fluctuates to deteriorate the operation performance of the engine.

### SUMMARY OF THE INVENTION

The present invention has been developed to solve the above problem, and an object thereof is to improve the accuracy of a plunger stroke, thereby minimizing the fluctuations of the discharge amount of an acceleration fuel in a carburetor with an acceleration pump.

To achieve the above object, according to the present invention, there is provided a carburetor with an acceleration pump, comprising an acceleration pump mechanism including: a cylinder which introduces a fuel from a float chamber side; a rod which performs a reciprocating operation in an axial direction via a link system interlocked with the opening/closing of a throttle valve while the tip of the rod is inserted into the cylinder; a plunger which is pressed by the tip of the rod to lower and which rises owing to the repulsive force of a return spring, to slidably reciprocate through the cylinder; a guide member which is a vertically extending insertion hole disposed above the plunger to guide the rod along a stroke thereof; and an acceleration fuel passage through which the fuel compressed by the plunger is supplied to a suction passage side, wherein the operational error of the link system is eliminated through a gap formed between the tip of the rod and the rod abutment face of the plunger and having a predetermined width at the position of the top dead center of the plunger.

In a conventional carburetor with an acceleration pump, the tip of a rod constantly comes in contact with a plunger, and hence a plunger stroke is directly influenced by an error generated in a link system of an acceleration pump mechanism, whereby the error is easily generated in the discharge amount of an acceleration fuel. On the other hand, in the present invention, the gap is formed between the plunger and the rod at the position of the top dead center of the plunger, thereby eliminating the error of the link system. In consequence, the rod simply abuts on the rod abutment face of the plunger to depress the plunger, whereby correct plunger stroke and discharge amount are easily acquired.

Moreover, in this case, when the guide member is disposed as a stopper for the plunger at such a position as to regulate the position of the top dead center of the plunger, the correct plunger stroke can easily be realized without incurring any cost increase.

According to the present invention, the gap is formed between the plunger and the rod at the position of the top dead center of the plunger, and the error of the link system is eliminated through the gap, whereby the accuracy of the plunger stroke can be improved to minimize the fluctuations of the discharge amount of the acceleration fuel.

### BRIEF DESCRIPTION OF THE DRAWINGS

FIG. 1 is a vertical sectional view showing an embodiment of the present invention;

FIG. 2 is a graph showing the average amount of an acceleration fuel to be discharged by a carburetor with an acceleration pump of FIG. 1;

FIG. 3 is a vertical sectional view showing a conventional example; and

FIG. 4 is a graph showing the average amount of an acceleration fuel to be discharged by a carburetor with an acceleration pump of FIG. 3.

### DESCRIPTION OF THE PREFERRED EMBODIMENTS

Hereinafter, the best mode for carrying out the present invention will be described with reference to the drawings.

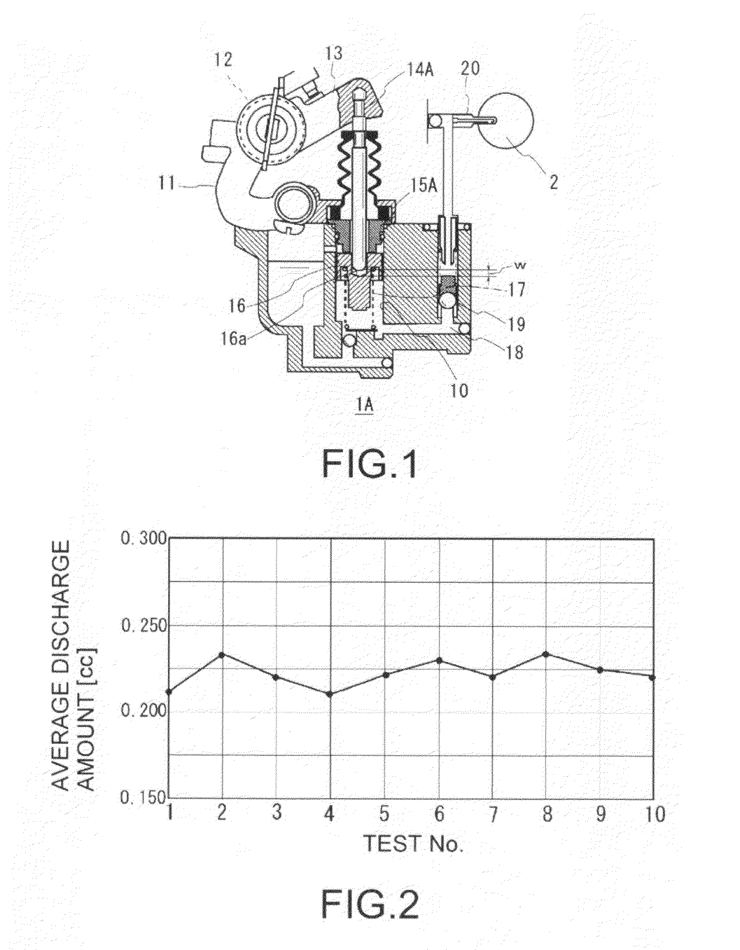

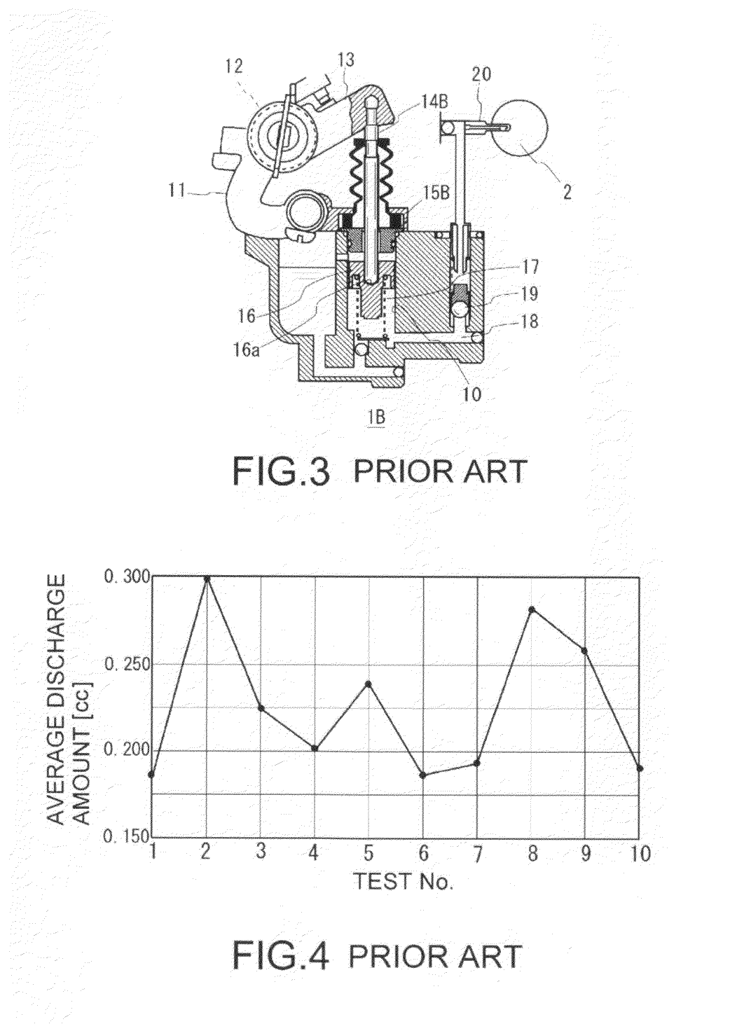

FIG. 1 shows a vertical sectional view (a part thereof is omitted) of a carburetor 1A with an acceleration pump of the present embodiment. The basic constitution of the carburetor with the acceleration pump is similar to that of the above carburetor 1B with the acceleration pump of FIG. 3, and hence the description thereof is omitted. Hereinafter, the constitution and function of a characteristic part in an acceleration pump mechanism will be described in detail.

In the carburetor 1A with the acceleration pump of the present embodiment, when a plunger 16 is stopped at the position of a top dead center in a cylinder 10 and the acceleration pump mechanism is not operated as in an idle operation or the like, a gap w having a predetermined width is formed between the tip of a rod 14A and a rod abutment face 16a of the plunger 16, whereby an operational error generated in a link system which transmits the opening/closing operation of a throttle valve to the rod is eliminated through this gap.

Moreover, in the present embodiment, a guide member 15A for guiding the rod 14A in a stroke direction thereof also serves as a stopper for the plunger 16, and is disposed so as to regulate the upper stroke of the plunger 16. The dimensions of components are determined so that the gap w is formed between the rod 14A and the rod abutment face 16a of the plunger 16 at the position of the top dead center of the plunger 16 where the acceleration pump mechanism is not operated.

In this way, the guide member 15A regulates the position of the top dead center of the plunger 16, and at the position, the gap w through which the error can be eliminated is formed between the rod 14A and the plunger 16, whereby it is possible to eliminate, through the portion of this gap w, the operational error of the link system due to the dimensional errors of the link system components, fluctuations during the assembly of the components or the like. In consequence, the fluctuations of the discharge amount of the acceleration fuel can be decreased, and a high engine operation performance during acceleration can be exerted.

FIG. 2 is a graph showing the average discharge amount of the acceleration fuel during the operation of the acceleration pump mechanism of the carburetor with the acceleration pump according to the present embodiment, and FIG. 4 is a graph showing the average discharge amount of the acceleration fuel during the operation of an acceleration pump mechanism of a carburetor with an acceleration pump according to a conventional example.

It is seen from comparison between these graphs of FIGS. 2 and 4 that the fluctuations of the average discharge amount are apparently small in the carburetor with the acceleration pump of the present embodiment. Therefore, the employment of the carburetor with the acceleration pump of the present embodiment obviates the need for a special regulation mechanism which regulates the discharge amount of the acceleration fuel and also obviates the need for an operation of regulating the discharge amount of the acceleration fuel after the assembly of the components.

As described above, in a carburetor with an acceleration pump according to the present invention, the accuracy of a plunger stroke is improved, and the fluctuations of the discharge amount of an acceleration fuel are minimized.

1. A carburetor with an acceleration pump, comprising an acceleration pump mechanism including: a cylinder which introduces a fuel from a float chamber side; a rod which performs a reciprocating operation in an axial direction via a link system interlocked with the opening/closing of a throttle valve while the tip of the rod is inserted into the cylinder; a plunger which is pressed by the tip of the rod to lower and which rises owing to the repulsive force of a return spring, to slidably reciprocate through the cylinder; a guide member which is a vertically extending insertion hole disposed above the plunger to guide the rod along a stroke thereof; and an acceleration fuel passage through which the fuel compressed by the plunger is supplied to a suction passage side, wherein the operational error of the link system is eliminated through a gap formed between the tip of the rod and the rod abutment face of the plunger and having a predetermined width at the position of the top dead center of the plunger.

2. The carburetor with the acceleration pump according to claim 1, wherein the guide member is disposed as a stopper for the plunger at such a position as to regulate the position of the top dead center of the plunger.
